(19) United States
(12) Patent Application Publication
(10) Pub. No.: US 2025/0313333 A1
(43) Pub. Date: Oct. 9, 2025

(54) Axially Aligned Triplex Linear Hydraulic Actuators

(71) Applicant: Textron Innovations Inc., Providence, RI (US)

(72) Inventor: Robert Paul Reynolds, Euless, TX (US)

(73) Assignee: Textron Innovations Inc., Providence, RI (US)

(21) Appl. No.: 18/630,564

(22) Filed: Apr. 9, 2024

(51) Int. Cl. B64C 13/24; B64C 5/10; B64C 27/64

(52) U.S. Cl. CPC B64C 13/24; B64C 5/10; B64C 27/64

(57) ABSTRACT

An aircraft control system for positioning an aircraft component includes an actuator having an outer cylinder, a rod disposed at least partially within the outer cylinder and first, second and third pistons coupled to the rod. The rod is linearly displaceable relative to the outer cylinder between a plurality of positions including a retracted position and an extended position. The first, second and third pistons are slidably and sealing received within the outer cylinder. A hydraulic system has a first fluid volume configured to act on the first piston forming a first actuator stage, a second fluid volume configured to act on the second piston forming a second actuator stage and a third fluid volume configured to act on the third piston forming a third actuator stage. The first, second and third fluid volumes are separately controllable. The first, second and third actuator stages are axially aligned.

### GOVERNMENT RIGHTS

This invention was made with Government support under Agreement No. W911W6-19-9-0002, awarded by the Army Contracting Command-Redstone Arsenal. The Government has certain rights in the invention.

### TECHNICAL FIELD OF THE DISCLOSURE

The present disclosure relates, in general, to linear actuators that are operable to move an object along a straight path and, in particular, to axially aligned triplex linear hydraulic actuators used in aircraft control systems to provide triple redundancy for controlling the position of aircraft components.

### BACKGROUND

Modern rotorcraft commonly including actively controllable horizontal stabilizers on each side of a tailboom that extends aftward from the fuselage. The horizontal stabilizers may be movable about a rotation axis so that the leading edges of the horizontal stabilizers can be angularly displaced about the rotation axis. Moving the horizontal stabilizers about the rotational axis can selectively affect the spatial orientation of the rotorcraft, such as the pitch or angle of attack of the fuselage, during forward flight. In addition, rotating the horizontal stabilizers can aid in maintaining a desired spatial orientation of the rotorcraft during transient environmental disturbances and can improve the efficiency of maneuvers during forward flight. Further, for rotorcraft that include wings, controlling the positions of the horizontal stabilizers can be useful during entry into emergency autorotation and maintenance of efficient autorotation, by minimizing the upward lift generated by the wings and maximizing the airflow into the rotor system.

The angular position and rotational movement of the horizontal stabilizers are typically determined using a control system that may include, for example, computer systems, hydraulic systems and actuation systems. The control system may receive inputs from a variety of sources including, for example, sensors, the pilot, an autopilot system, a full authority digital engine control and/or the flight control computer. Based upon the inputs, the control system generates commands that cause the horizontal stabilizers to rotate. In order to provide redundancy, improve safety and enhance fault tolerance, the actuators in such control systems are commonly dual or triplex linear hydraulic actuators that are operated in conjunction with multiple independent hydraulic fluid sources.

### SUMMARY

In a first aspect, the present disclosure is directed to an aircraft control system for positioning an aircraft component. The aircraft control system includes an actuator having an outer cylinder, a rod disposed at least partially within the outer cylinder and first, second and third pistons coupled to the rod. The rod is linearly displaceable relative to the outer cylinder between a plurality of positions including a retracted position and an extended position. The first, second and third pistons are slidably and sealing received within the outer cylinder. A hydraulic system has first, second and third fluid volumes with the first fluid volume configured to act on the first piston to form a first actuator stage, the second fluid volume configured to act on the second piston to form a second actuator stage and the third fluid volume configured to act on the third piston to form a third actuator stage. The first, second and third fluid volumes are separately controllable. The first, second and third actuator stages are axially aligned.

In some embodiments, the hydraulic system may include a first hydraulic subsystem configured to control the first fluid volume, a second hydraulic subsystem configured to control the second fluid volume and a third hydraulic subsystem configured to control the third fluid volume. In certain embodiments, the first hydraulic subsystem may include a first hydraulic reservoir, a first hydraulic pump and a first hydraulic valve assembly, the second hydraulic subsystem may include a second hydraulic reservoir, a second hydraulic pump and a second hydraulic valve assembly, and the third hydraulic subsystem may include a third hydraulic reservoir, a third hydraulic pump and a third hydraulic valve assembly. In other embodiments, the first hydraulic subsystem may include a first hydraulic reservoir, a first electric motor and a first hydraulic valve assembly, the second hydraulic subsystem may include a second hydraulic reservoir, a second electric motor and a second hydraulic valve assembly, and the third hydraulic subsystem may include a third hydraulic reservoir, a third electric motor and a third hydraulic valve assembly.

In some embodiments, a first flight control computer may be operably associated with the first hydraulic subsystem, a second flight control computer may be operably associated with the second hydraulic subsystem and a third flight control computer may be operably associated with the third hydraulic subsystem. In certain embodiments, the actuator may include a linear variable differential transformer that is configured to convert linear displacements of the rod relative to the outer cylinder into proportional electrical signals sent to the first, second and third flight control computers. In other embodiments, the actuator may include a triplex linear variable differential transformer that is configured to convert linear displacements of the rod relative to the outer cylinder into first, second and third proportional electrical signals that are respectively sent to the first, second and third flight control computers. In some embodiments, the first actuator stage may include a first extend chamber and a first retract chamber positioned on opposite sides of the first piston and disposed between the outer cylinder and the rod, the second actuator stage may include a second extend chamber and a second retract chamber positioned on opposite sides of the second piston and disposed between the outer cylinder and the rod, and the third actuator stage may include a third extend chamber and a third retract chamber positioned on opposite sides of the third piston and disposed between the outer cylinder and the rod.

In certain embodiments, the first piston may include a first extend surface and a first retract surface, the second piston may include a second extend surface and a second retract surface, and the third piston may include a third extend surface and a third retract surface. In such embodiments, fluid from the first fluid volume in the first extend chamber acting on the first extend surface may urge the rod toward the extended position, fluid from the second fluid volume in the second extend chamber acting on the second extend surface may urge the rod toward the extended position, and fluid from the third fluid volume in the third extend chamber acting on the third extend surface may urge the rod toward the extended position. Also, in such embodiments, fluid from the first fluid volume in the first retract chamber acting on the first retract surface may urge the rod toward the retracted position, fluid from the second fluid volume in the second retract chamber acting on the second retract surface may urge the rod toward the retracted position, and fluid from the third fluid volume in the third retract chamber acting on the third retract surface may urge the rod toward the retracted position.

In some embodiments, first and second seal assemblies may be disposed between the outer cylinder and the rod such that the first seal assembly isolates the first fluid volume in the first actuator stage from the second fluid volume in the second actuator stage and such that the second seal assembly isolates the second fluid volume in the second actuator stage from the third fluid volume in the third actuator stage. In certain embodiments, responsive to a malfunction in one of the three actuator stages, the other two of the three actuator stages are configured to linearly displace the rod relative to the outer cylinder between the plurality of positions, thereby providing redundancy to the aircraft control system. In some embodiments, responsive to a malfunction in two of the three actuator stages, the other of the three actuator stages is configured to linearly displace the rod relative to the outer cylinder between the plurality of positions, thereby providing redundancy to the aircraft control system. In certain embodiments, the first, second and third actuator stages may be axially aligned in series such that the first, second and third actuator stages are positioned in an end-to-end coaxial arrangement.

In a second aspect, the present disclosure is directed to an aircraft that includes an airframe and an aircraft component that is coupled to and selectively positionable relative to the airframe. An actuator includes an outer cylinder, a rod disposed at least partially within the outer cylinder and first, second and third pistons coupled to the rod. The outer cylinder is coupled to the airframe. The rod is coupled to the aircraft component and is linearly displaceable relative to the outer cylinder between a plurality of positions including a retracted position and an extended position. The first, second and third pistons are slidably and sealing received within the outer cylinder. A hydraulic system has first, second and third fluid volumes with the first fluid volume configured to act on the first piston to form a first actuator stage, the second fluid volume configured to act on the second piston to form a second actuator stage and the third fluid volume configured to act on the third piston to form a third actuator stage. The first, second and third fluid volumes are separately controllable. The first, second and third actuator stages are axially aligned.

In some embodiments, the aircraft may be a rotorcraft. In certain embodiments, the aircraft component may be a flight control surface such as a horizontal stabilizer, a vertical stabilizer, an aileron, an elevator, a rudder, a ruddervator, a flaperon or an elevon. In some embodiments, the outer cylinder may include a pin end coupled to the airframe and the rod may have a pin end coupled to the aircraft component such that linear displacement of the rod relative to the outer cylinder changes a position of the aircraft component relative to the airframe.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1C are schematic illustrations of a rotorcraft having an aircraft control system including an axially aligned triplex linear hydraulic actuator in accordance with embodiments of the present disclosure;

FIGS. 2A-2F are various views of an axially aligned triplex linear hydraulic actuator of an aircraft control system that is controlling the position of an aircraft component in accordance with embodiments of the present disclosure;

FIGS. 3A-3D are side and partial cross sectional views of an axially aligned triplex linear hydraulic actuator of an aircraft control system in various operating configurations in accordance with embodiments of the present disclosure;

FIG. 4 is a block diagram of an aircraft control system including an axially aligned triplex linear hydraulic actuator in accordance with embodiments of the present disclosure;

FIGS. 5A-5B are block diagrams of component parts of an aircraft control system in accordance with embodiments of the present disclosure;

FIG. 6 is a partial cross sectional view of an axially aligned triplex linear hydraulic actuator in accordance with embodiments of the present disclosure;

FIG. 7 is a partial cross sectional view of an axially aligned triplex linear hydraulic actuator in accordance with embodiments of the present disclosure; and

FIG. 8 is a partial cross sectional view of an axially aligned triplex linear hydraulic actuator in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

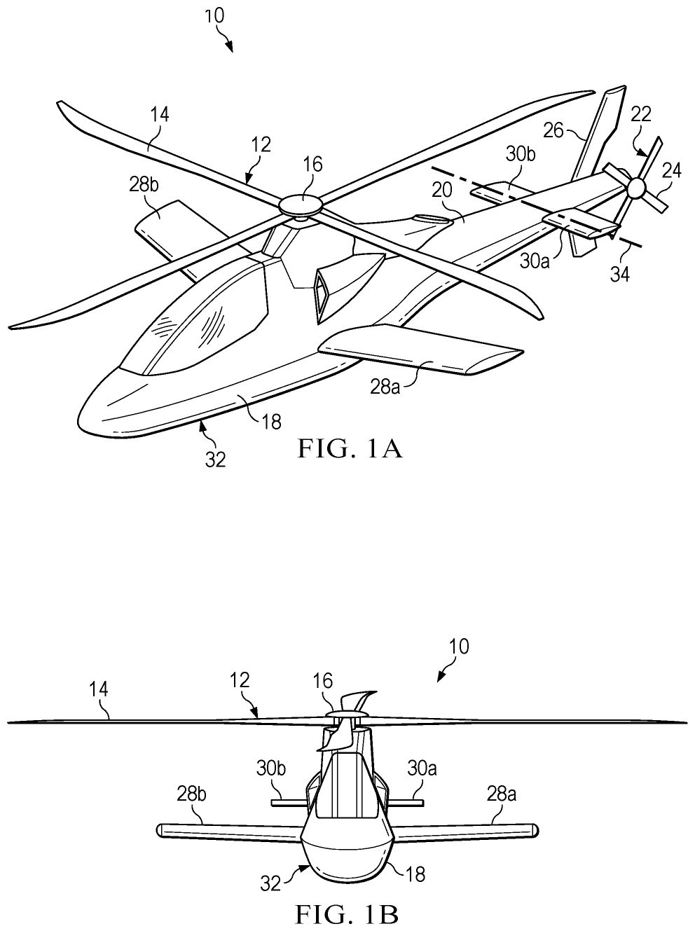

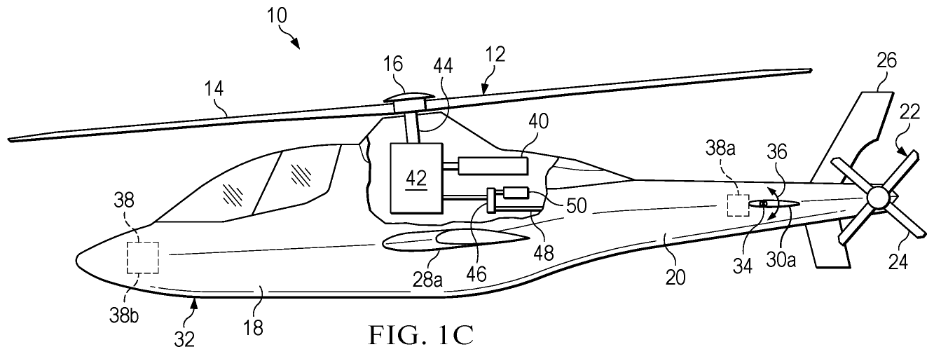

Referring to FIGS. 1A-1C in the drawings, an aircraft in the form of a rotorcraft is schematically depicted as helicopter 10. The primary propulsion assembly of helicopter 10 is a main rotor 12. Main rotor 12 includes a plurality of rotor blades 14 extending radially outward from a main rotor hub 16. Main rotor 12 is coupled to a fuselage 18 and is rotatable relative thereto. The pitch of rotor blades 14 can be collectively and/or cyclically manipulated to selectively control direction, thrust and lift of helicopter 10. A tailboom 20 is coupled to fuselage 18 and extends from fuselage 18 in the aft direction. Anti-torque is provided to helicopter 10 by a tail rotor system 22 that includes a tail rotor 24. Tail rotor system 22 controls the yaw of helicopter 10 by counteracting the torque exerted on fuselage 18 by main rotor 12. In the illustrated embodiment, helicopter 10 includes a vertical tail fin 26 that provide stabilization to helicopter 10 during high-speed forward flight. In the illustrated embodiment, helicopter 10 includes a pair of wings 28a, 28b that extend laterally from fuselage 18 and a pair of active control surfaces depicted as horizontal stabilizers 30a, 30b that extend laterally from tailboom 20. In other embodiments, an aircraft of the present disclosure could have additional or alternative active control surfaces including, but not limited to, vertical stabilizers, ailerons, elevators, rudders, ruddervators, flaperons, elevons or other moveable aerosurface. Wings 28a, 28b provide lift compounding to helicopter 10 responsive to the forward airspeed of helicopter 10, thereby reducing the lift requirement on main rotor 12 and increasing the top speed of helicopter 10. Together, fuselage 18, tailboom 20 and wings 28a, 28b as well as their various frames, beams, supports, longerons, stringers, bulkheads, formers, spars, ribs, skins and the like are considered to be the airframe 32 of helicopter 10.

Horizontal stabilizers 30a, 30b are rotatably coupled to tailboom 20 and are operable to pivot about axis 34, as indicated by arrows 36, such that horizontal stabilizers 30a, 30b can be angularly displaced relative to tailboom 20. Pivoting horizontal stabilizers 30a, 30b relative to tailboom 20 may be accomplished to selectively affect the spatial orientation of helicopter 10, such as the pitch or angle of attack of fuselage 18, during forward flight. In addition, such active operations of horizontal stabilizers 30a, 30b can aid in maintaining a desired spatial orientation during transient environmental disturbances and can improve the efficiency of maneuvers during forward flight. Active operations of horizontal stabilizers 30a, 30b can also be useful during entry into emergency autorotation and maintenance of efficient autorotation, by minimizing the upward lift generated by wings 28a, 28b and maximizing the airflow into main rotor 12. The angular position and rotational movement horizontal stabilizers 30a, 30b is managed using an aircraft control system 38. In the illustrated embodiment, aircraft control system 38 includes multiple components that are distributed throughout a variety of locations within helicopter 10 including a redundant hydraulic actuation system 38a including, for example, a triplex linear hydraulic actuator with three independent hydraulic subsystems, and a redundant flight control computer system 38b including, for example, three independent flight control computers.

Main rotor 12 receive torque and rotational energy from a powertrain including a main engine 40, a main rotor gearbox 42 and a mast 44. Main rotor gearbox 42 is coupled to tail rotor system 22 through a secondary gearbox 46 and a tail rotor drive shaft 48. In the illustrated embodiment, helicopter 10 includes a secondary engine 50 that is coupled to secondary gearbox 46. Secondary engine 50 may operate as an auxiliary power unit to provide preflight power to the accessories of helicopter 10 such as electric generators, air pumps, oil pumps, hydraulic systems and the like as well as to provide the power required to start main engine 40. In addition, secondary engine 50 may operate as supplemental power unit to provide additive power or emergency power to main rotor 12.

It should be appreciated that helicopter 10 is merely illustrative of a variety of aircraft that can implement the embodiments disclosed herein. Indeed, the embodiments of the present disclosure may be implemented on any type of aircraft. Other aircraft implementations can include hybrid aircraft, unmanned aircraft, gyrocopters, compound helicopters, drones, fixed wing aircraft and the like. As such, those skilled in the art will recognize that the embodiments of the present disclosure can be integrated into a variety of aircraft configurations. It should be appreciated that even though aircraft are particularly well-suited to implement the embodiments of the present disclosure, non-aircraft vehicles and devices can also implement the embodiments.

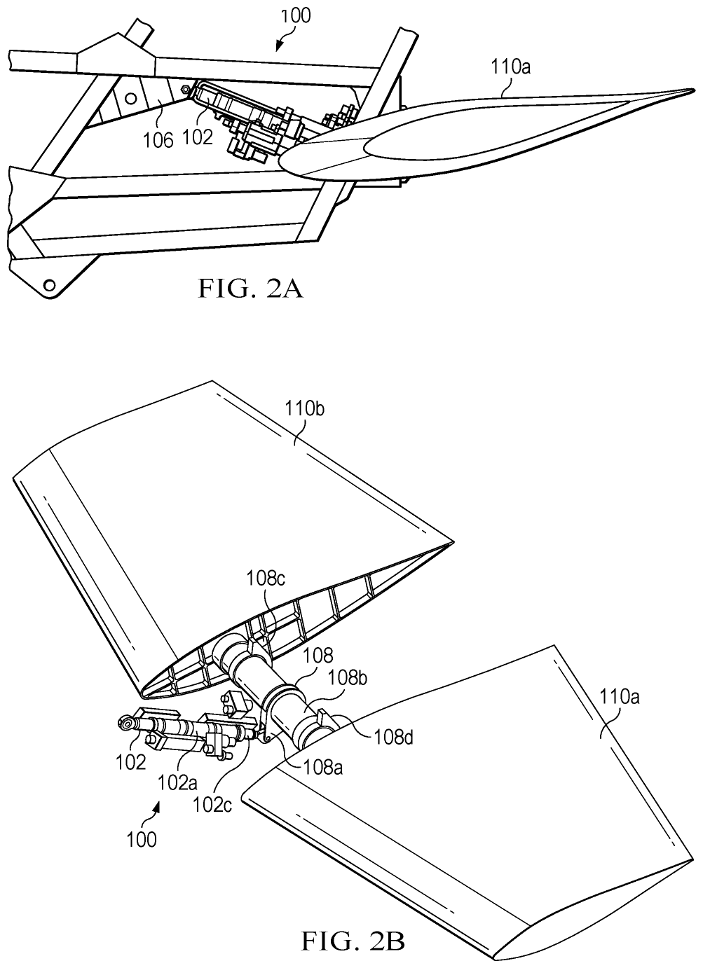

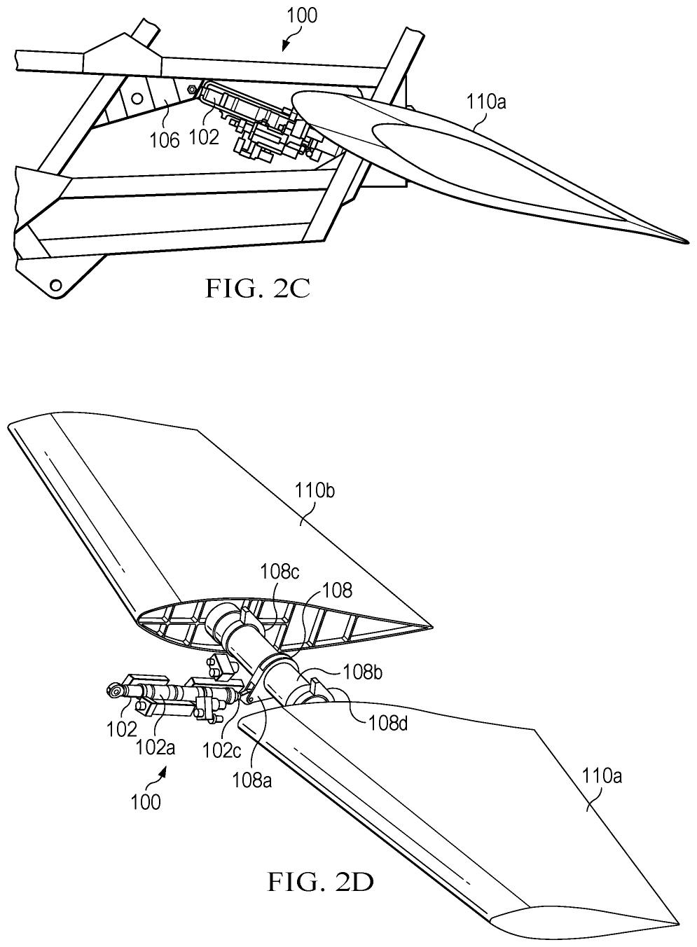

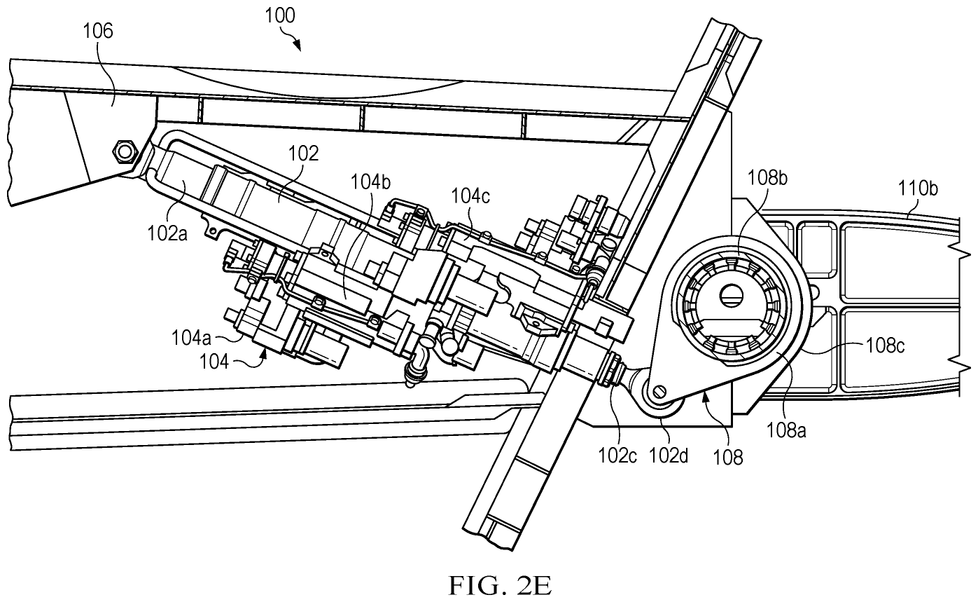

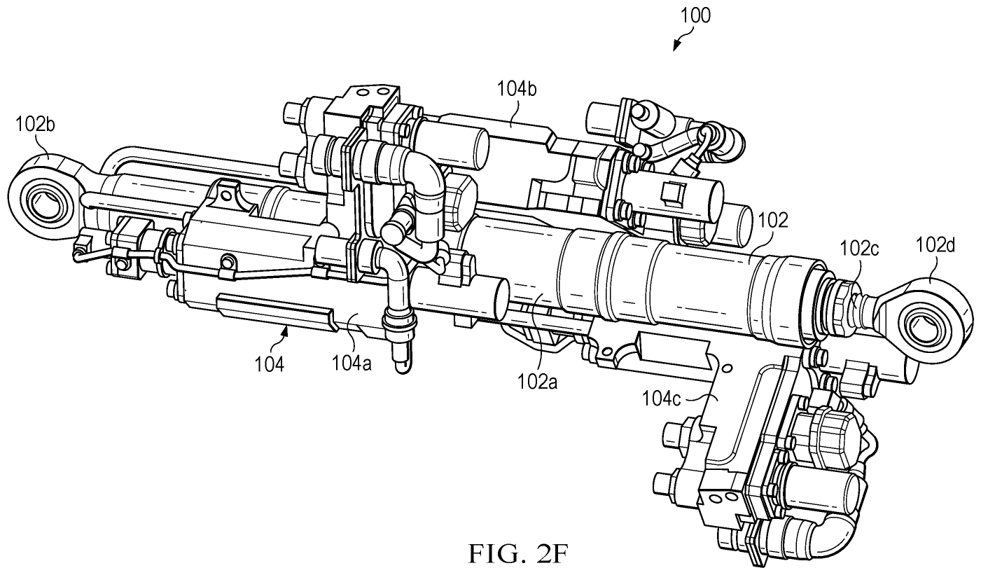

Referring now to FIGS. 2A-2F in the drawings, a redundant hydraulic actuation system 100, that is representative of redundant hydraulic actuation system 38a, for controlling the position of aircraft component will now be discussed. In the illustrated embodiment, redundant hydraulic actuation system 100 includes an axially aligned triplex linear hydraulic actuator 102 that is shiftable between a plurality of positions including an extended position (FIGS. 2A-2B), a retracted position (FIGS. 2C-2D) and an infinite number of positioned therebetween. Hydraulic actuator 102 is operated responsive to hydraulic pressure provided by a hydraulic system 104 that includes three independent hydraulic subsystems 104a, 104b, 104c. For example, hydraulic system 104 may be an electro-hydraulic system, an electro-hydrostatic system or other suitable self-contained hydraulic system capable of providing multiple independent hydraulic networks. As discussed herein, each of hydraulic subsystems 104a, 104b, 104c is capable of fully operating hydraulic actuator 102 independent of and without the assistance of any of the other hydraulic subsystems 104a, 104b, 104c, thereby providing triple redundancy to hydraulic system 104. In the illustrated embodiment, hydraulic subsystems 104a, 104b, 104c are coupled to hydraulic actuator 102 such that hydraulic subsystems 104a, 104b, 104c are longitudinally and circumferentially distributed about hydraulic actuator 102.

More specifically, hydraulic subsystem 104a is coupled to hydraulic actuator 102 such that hydraulic subsystem 104a is positioned relative to and in fluid communication with a first actuator stage of hydraulic actuator 102 enabling the hydraulic fluid volume controlled by hydraulic subsystem 104a to act on a piston of hydraulic actuator 102 disposed within the first actuator stage. Likewise, hydraulic subsystem 104b is coupled to hydraulic actuator 102 such that hydraulic subsystem 104b is positioned relative to and in fluid communication with a second actuator stage of hydraulic actuator 102 enabling the hydraulic fluid volume controlled by hydraulic subsystem 104b to act on a piston of hydraulic actuator 102 disposed within the second actuator stage. In addition, hydraulic subsystem 104c is coupled to hydraulic actuator 102 such that hydraulic subsystem 104c is positioned relative to and in fluid communication with a third actuator stage of hydraulic actuator 102 enabling the hydraulic fluid volume controlled by hydraulic subsystem 104c to act on a piston of hydraulic actuator 102 disposed within the third actuator stage. As discussed herein, each of the first, second and third actuator stages of hydraulic actuator 102 is capable of fully operating hydraulic actuator 102 independent of and without the assistance of any of the other actuator stages, thereby providing triple redundancy to hydraulic actuator 102 thus making hydraulic actuator 102 a triplex hydraulic actuator.

In the illustrated implementation, hydraulic actuator 102 includes an outer cylinder 102a that is coupled to an airframe structure 106 such as a bulkhead, a former, a frame other suitable structural member. For example, outer cylinder 102a may include a pin end 102b that is configured to receive a pin, a bolt or other suitable connecting member therethrough that securably couples outer cylinder 102a to airframe structure 106. Hydraulic actuator 102 also includes a rod 102c that is at least partially disposed within outer cylinder 102a and is linearly displaceable relative to outer cylinder 102a between a plurality of positions including the extended position (FIGS. 2A-2B), the retracted position (FIGS. 2C-2D) and an infinite number of positions therebetween. Rod 102c includes a pin end 102d that is coupled to a rotating system 108 of horizontal stabilizers 110a, 110b by a pin, a bolt or other suitable connecting member. In the illustrated embodiments, rotating system 108 includes a bell crank 108a that is non-rotatably coupled to a torque tube 108b that extends laterally between and is non-rotatably coupled to horizontal stabilizer 110a and horizontal stabilizer 110b. Torque tube 108b is rotatably supported by a pair of bearings 108c, 108d that are coupled to airframe structure 106. As best seen by comparing FIGS. 2B and 2D, linear displacement of rod 102c relative to outer cylinder 102a causes bell crank 108a to rotate which in turn causes torque tube 108b, and thus horizontal stabilizers 110a, 110b, to rotate relative to the tailboom enabling horizontal stabilizers 110a, 110b to apply the desired longitudinal or pitch moment on the aircraft.

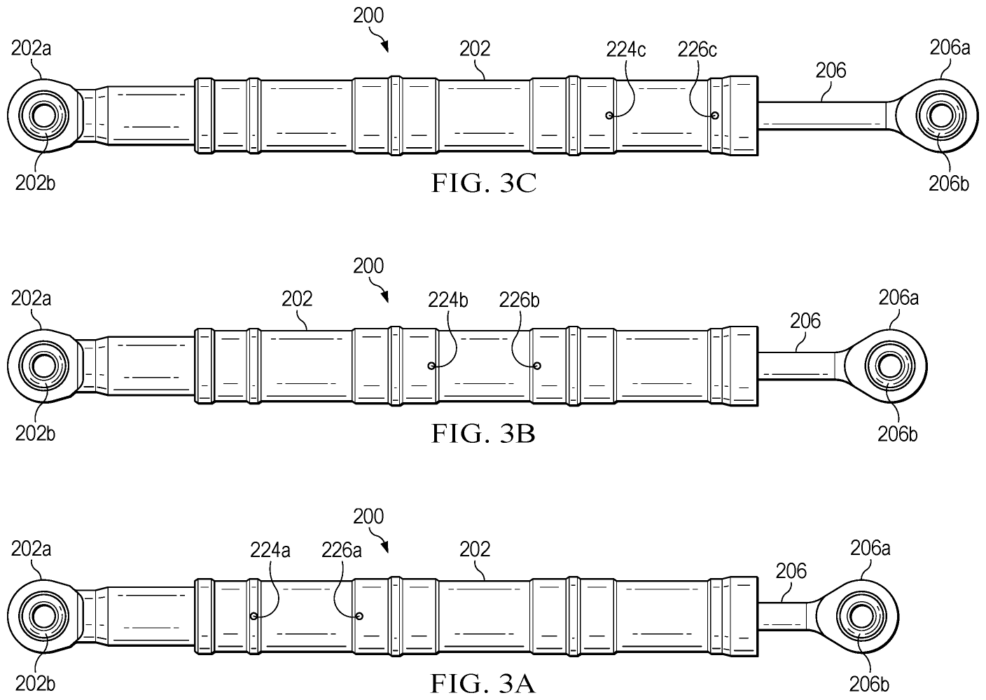

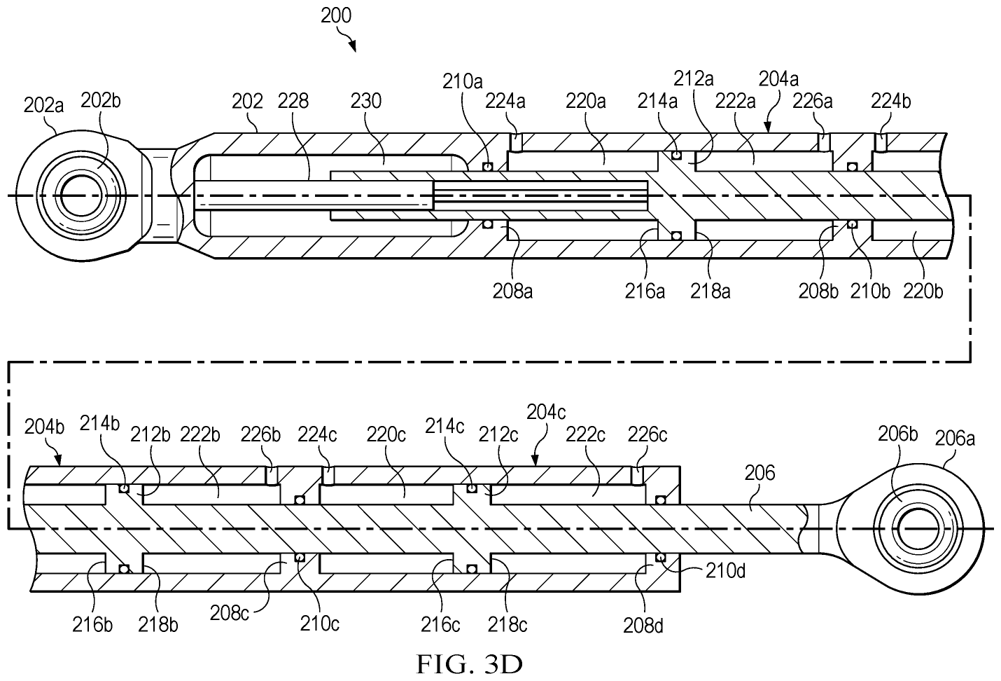

Referring next to FIGS. 3A-3D in the drawings, an axially aligned triplex linear hydraulic actuator 200, that is representative of axially aligned triplex linear hydraulic actuator 102, will now be discussed. Hydraulic actuator 200 has outer cylinder 202 formed as a hollow tubular member from metal, such as steel, or other suitable material. Outer cylinder 202 has a generally cylindrical outer surface and generally cylindrical inner surface. Outer cylinder 202 has a pin end 202a that houses a spherical bearing 202b configured for coupling hydraulic actuator 200 to another structure, such as airframe structure 106 discussed herein. Outer cylinder 202 encloses a volume that is divided into three actuator stages 204a, 204b, 204c that act individually and/or collectively to linearly displace a rod 206 between a plurality of positions including a retracted position (see FIG. 3A), an extended position (see FIG. 3C) and an infinite number of positions therebetween (see e.g., FIGS. 3B and 3D). Actuator stages 204a, 204b, 204c are positioned within hydraulic actuator 200 in an end-to-end coaxial arrangement which may be referred to herein as being axially aligned in series. Rod 206 extends through each of actuator stages 204a, 204b, 204c. Rod 206 may be constructed from one or more solid and/or hollow tubular members formed from metal, such as steel, or other suitable material. Rod 206 has a pin end 206a that houses a spherical bearing 206b configured for coupling hydraulic actuator 200 to another component, such as to rotating system 108 used to pivot horizontal stabilizers 110a, 110b, as discussed herein.

Hydraulic actuator 200 includes a plurality of seal assemblies including an end seal assembly 208a, an intermediate seal assembly 208b, an intermediate seal assembly 208c and an end seal assembly 208d, each of which may be coupled to or integrally formed with outer cylinder 202. Seal assembly 208a is sized to have a sliding and sealing relationship with rod 206 created by a seal element, depicted as an O-ring 210a, that is received within an inner gland of seal assembly 208a. Seal assembly 208b is sized to have a sliding and sealing relationship with rod 206 created by a seal element, depicted as an O-ring 210b, that is received within an inner gland of seal assembly 208b. Seal assembly 208c is sized to have a sliding and sealing relationship with rod 206 created by a seal element, depicted as an O-ring 210c, that is received within an inner gland of seal assembly 208c. Seal assembly 208d is sized to have a sliding and sealing relationship with rod 206 created by a seal element, depicted as an O-ring 210d, that is received within an inner gland of seal assembly 208d.

A piston 212a is coupled to rod 206 and, in the illustrated embodiment, is integrally formed with rod 206. Piston 212a includes an outer gland that is configured to receive a seal element, depicted as an O-ring 214a, therein. Piston 212a is sized such that O-ring 214a has a sliding and sealing relationship with the inner cylindrical surface of outer cylinder 202. Piston 212a has opposing surfaces referred to herein as extend surface 216a and retract surface 218a. Together, seal assembly 208a, piston 212a, the inner cylindrical surface of outer cylinder 202 and the outer surface of rod 206 form a generally annular extend chamber 220a. Similarly, seal assembly 208b, piston 212a, the inner cylindrical surface of outer cylinder 202 and the outer surface of rod 206 form a generally annular retract chamber 222a. Fluid from the hydraulic fluid volume controlled by the respective hydraulic subsystem, such as hydraulic subsystem 104a discussed above, enters and exits extend chamber 220a via an extend port 224a. Likewise, fluid from the hydraulic fluid volume controlled by the respective hydraulic subsystem enters and exits retract chamber 222a via a retract port 226a. Extend chamber 220a, retract chamber 222a and piston 212a are part of actuator stage 204a such that when the hydraulic subsystem supplies hydraulic fluid to extend chamber 220a via extend port 224a and withdraws hydraulic fluid from retract chamber 222a via retract port 226a, the hydraulic fluid pressure in extend chamber 220a acts on extend surface 216a of piston 212a which urges rod 206 toward the extended position, and such that when the hydraulic subsystem supplies hydraulic fluid to retract chamber 222a via retract port 226a and withdraws hydraulic fluid from extend chamber 220a via extend port 224a, the hydraulic fluid pressure in retract chamber 222a acts on retract surface 218a of piston 212a which urges rod 206 toward the retracted position.

A piston 212b is coupled to rod 206 and, in the illustrated embodiment, is integrally formed with rod 206. Piston 212b includes an outer gland that is configured to receive a seal element, depicted as an O-ring 214b, therein. Piston 212b is sized such that O-ring 214b has a sliding and sealing relationship with the inner cylindrical surface of outer cylinder 202. Piston 212b has opposing surfaces referred to herein as extend surface 216b and retract surface 218b. Together, seal assembly 208b, piston 212b, the inner cylindrical surface of outer cylinder 202 and the outer surface of rod 206 form a generally annular extend chamber 220b. Similarly, seal assembly 208c, piston 212b, the inner cylindrical surface of outer cylinder 202 and the outer surface of rod 206 form a generally annular retract chamber 222b. Fluid from the hydraulic fluid volume controlled by the respective hydraulic subsystem, such as hydraulic subsystem 104b discussed above, enters and exits extend chamber 220b via an extend port 224b. Likewise, fluid from the hydraulic fluid volume controlled by the respective hydraulic subsystem enters and exits retract chamber 222b via a retract port 226b. Extend chamber 220b, retract chamber 222b and piston 212b are part of actuator stage 204b such that when the hydraulic subsystem supplies hydraulic fluid to extend chamber 220b via extend port 224b and withdraws hydraulic fluid from retract chamber 222b via retract port 226b, the hydraulic fluid pressure in extend chamber 220b acts on extend surface 216b of piston 212b which urges rod 206 toward the extended position, and such that when the hydraulic subsystem supplies hydraulic fluid to retract chamber 222b via retract port 226b and withdraws hydraulic fluid from extend chamber 220b via extend port 224b, the hydraulic fluid pressure in retract chamber 222b acts on retract surface 218b of piston 212b which urges rod 206 toward the retracted position.

A piston 212c is coupled to rod 206 and, in the illustrated embodiment, is integrally formed with rod 206. Piston 212c includes an outer gland that is configured to receive a seal element, depicted as an O-ring 214c, therein. Piston 212c is sized such that O-ring 214c has a sliding and sealing relationship with the inner cylindrical surface of outer cylinder 202. Piston 212c has opposing surfaces referred to herein as extend surface 216c and retract surface 218c. Together, seal assembly 208c, piston 212c, the inner cylindrical surface of outer cylinder 202 and the outer surface of rod 206 form a generally annular extend chamber 220c. Similarly, seal assembly 208d, piston 212c, the inner cylindrical surface of outer cylinder 202 and the outer surface of rod 206 form a generally annular retract chamber 222c. Fluid from the hydraulic fluid volume controlled by the respective hydraulic subsystem, such as hydraulic subsystem 104c discussed above, enters and exits extend chamber 220c via an extend port 224c. Likewise, fluid from the hydraulic fluid volume controlled by the respective hydraulic subsystem enters and exits retract chamber 222c via a retract port 226c. Extend chamber 220c, retract chamber 222c and piston 212c are part of actuator stage 204c such that when the hydraulic subsystem supplies hydraulic fluid to extend chamber 220c via extend port 224c and withdraws hydraulic fluid from retract chamber 222c via retract port 226c, the hydraulic fluid pressure in extend chamber 220c acts on extend surface 216c of piston 212c which urges rod 206 toward the extended position, and such that when the hydraulic subsystem supplies hydraulic fluid to retract chamber 222c via retract port 226c and withdraws hydraulic fluid from extend chamber 220c via extend port 224c, the hydraulic fluid pressure in retract chamber 222c acts on retract surface 218c of piston 212c which urges rod 206 toward the retracted position.

In the illustrated embodiment, hydraulic actuator 200 includes a variable differential transformer 228 that converts the linear displacement of rod 206 relative to outer cylinder 202 into a proportional electrical signal that is sent to flight control computer system 38b. Preferably, variable differential transformer 228 is a triplex linear variable differential transformer that is configured to convert the linear displacement of rod 206 relative to outer cylinder 202 into three independent proportional electrical signals that are respectively sent to the three independent flight control computers of flight control computer system 38b. In the illustrated embodiment, variable differential transformer 228 is isolated from the hydraulic fluid and is at least partially positioned within a dry chamber 230.

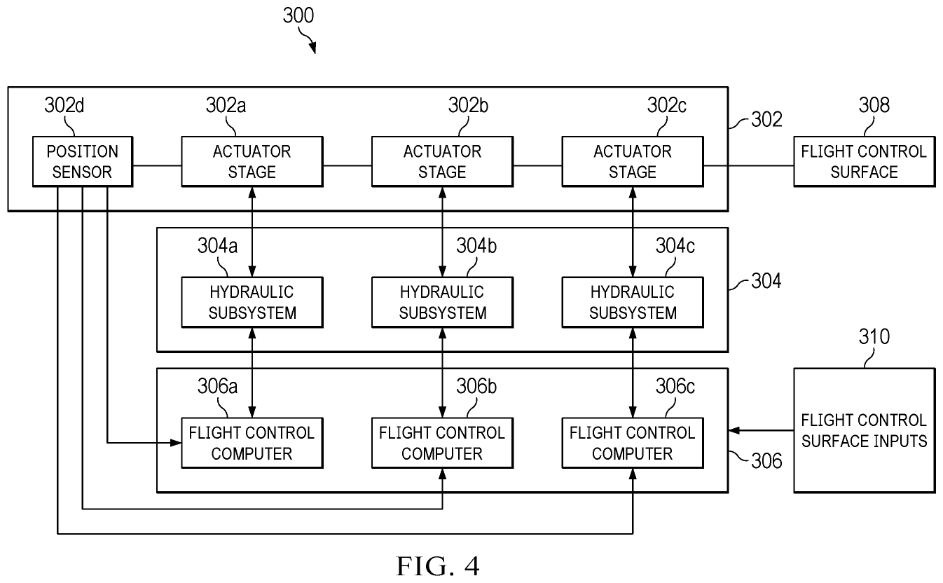

The operation of an aircraft control system 300 for positioning an aircraft component will now be discussed with reference to FIG. 4 in the drawings. Aircraft control system 300 includes an axially aligned triplex linear hydraulic actuator 302, that is representative of axially aligned triplex linear hydraulic actuators 102, 200 discussed herein. As illustrated, hydraulic actuator 302 includes an actuator stage 302a that is representative of actuator stage 204a discussed herein, an actuator stage 302b that is representative of actuator stage 204b discussed herein and an actuator stage 302c that is representative of actuator stage 204c discussed herein. Actuator stages 302a, 302b, 302c are axially aligned in series. Hydraulic actuator 302 also includes a position sensor 302d such as a triplex linear variable differential transformer that is representative of variable differential transformer 228 discussed herein.

A redundant hydraulic system 304, that is representative of hydraulic system 104 discussed herein, is operably associated with hydraulic actuator 302. In the illustrated embodiment, hydraulic system 304 includes three redundant hydraulic subsystems; namely, a hydraulic subsystem 304a that is representative of hydraulic subsystem 104a discussed herein, a hydraulic subsystem 304b that is representative of hydraulic subsystem 104b discussed herein and a hydraulic subsystem 304c that is representative of hydraulic subsystem 104c discussed herein. Hydraulic subsystem 304a is in fluid communication with actuator stage 302a, as indicated by the fluid communication arrow extending therebetween. Hydraulic subsystem 304b is in fluid communication with actuator stage 302b, as indicated by the fluid communication arrows extending therebetween. Hydraulic subsystem 304c is in fluid communication with actuator stage 302c, as indicated by the fluid communication arrow extending therebetween.

A redundant flight control computer system 306, that is representative of flight control computer system 38b discussed herein, is operably associated with hydraulic system 304 and hydraulic actuator 302. In the illustrated embodiment, flight control computer system 306 includes three redundant flight control computers; namely, a flight control computer 306a, a flight control computer 306b and a flight control computer 306c. Flight control computer 306a is in data communication with hydraulic subsystem 304a and position sensor 302d, as indicated by the data communication arrows extending therebetween. Flight control computer 306b is in data communication with hydraulic subsystem 304b and position sensor 302d, as indicated by the data communication arrows extending therebetween. Flight control computer 306c is in data communication with hydraulic subsystem 304c and position sensor 302d, as indicated by the data communication arrows extending therebetween.

In the illustrated embodiment, hydraulic actuator 302 is operably associated with an aircraft component, depicted as flight control surface 308, such as by a physical connection with the axially displaceable rod of hydraulic actuator 302. As discussed herein, hydraulic actuator 302 is configured to operate flight control surface 308 between a plurality of positions responsive to the axial displacement of the rod of hydraulic actuator 302 between a retracted position, an extended position and an infinite number of positions therebetween. Flight control surface 308 may be any type of flight control surface such as a horizontal stabilizer, a vertical stabilizer, an aileron, an elevator, a rudder, a ruddervator, a flaperon or an elevon, to name a few. In other implementations, flight control surface 308 could be a rotary component such as the blades of a main rotor, a tail rotor or other rotor system, in which case, hydraulic actuator 302 may be used to control blade pitch.

Flight control computer system 306 is operably associated one or more flight control surface inputs 310, as indicated by the data communication arrow extending therebetween. Inputs 310 come from a variety of sources such as sensors, pilot controls, an autopilot system, a full authority digital engine control and other sources. Flight control computer system 306 and more specifically each of flight control computers 306a, 306b, 306c processes the data received from inputs 310 and the data from position sensor 302d to generate commands for hydraulic system 304. In the illustrated embodiment, flight control computer 306a send commands to hydraulic subsystem 304a, flight control computer 306b send commands to hydraulic subsystem 304b and flight control computer 306c send commands to hydraulic subsystem 304c over the respective data channels therebetween. In this manner, hydraulic subsystems 304a, 304b, 304c are separately controllable respectively by flight control computers 306a, 306b, 306c.

Hydraulic system 304 responds to the computer commands by supplying fluid to and withdrawing fluid from the chambers within hydraulic actuator 302, such as extend chambers 220a, 220b, 220c and retract chambers 222a, 222b, 222c discussed herein. In the illustrated embodiment, hydraulic subsystem 304a supplies fluid to and withdraws fluid from the chambers within actuator stage 302a, hydraulic subsystem 304b supplies fluid to and withdraws fluid from the chambers within actuator stage 302b and hydraulic subsystem 304c supplies fluid to and withdraws fluid from the chambers within actuator stage 302c via the respective fluid paths therebetween. In this manner, actuator stages 302a, 302b, 302c are separately controllable respectively by hydraulic subsystems 304a, 304b, 304c.

In a non-limiting example, when flight control computer system 306 receives data from inputs 310 that flight control surface 308 should be shifted from its current position to a new position, the input data is independently processed by each of flight control computers 306a, 306b, 306c. Responsive thereto, flight control computer 306a sends a command to hydraulic subsystem 304a to cause flight control surface 308 to be shifted to the new position, flight control computer 306b sends a command to hydraulic subsystem 304b to cause flight control surface 308 to be shifted to the new position and flight control computer 306c sends a command to hydraulic subsystem 304c to cause flight control surface 308 to be shifted to the new position. Responsive thereto, hydraulic subsystem 304a deploys its fluid volume relative to actuator stage 302a to cause flight control surface 308 to be shifted to the new position, hydraulic subsystem 304b deploys its fluid volume relative to actuator stage 302b to cause flight control surface 308 to be shifted to the new position and hydraulic subsystem 304c deploys its fluid volume relative to actuator stage 302c to cause flight control surface 308 to be shifted to the new position. The hydraulic fluid pressure acting on the pistons of actuator stages 302a, 302b, 302c, such as pistons 216a, 216b, 216c discussed herein, causes the rod of hydraulic actuator 302 to be linearly displaced relative to the outer cylinder of hydraulic actuator 302, which in turn cause flight control surface 308 to be shifted from its current position to the commanded position.

Position sensor 302d monitors the linear displacement of the rod relative to the outer cylinder and converts this linear displacement into three independent proportional electrical signals that are sent to flight control computers 306a, 306b, 306c over the respective data channels therebetween. Flight control computers 306a, 306b, 306c use this feedback data to determine, for example, the actual position of flight control surface 308 and any error between the actual position and the commanded position of flight control surface 308. If flight control computers 306a, 306b, 306c determine that an error has occurred, each of flight control computers 306a, 306b, 306c can respectively communicate a corrective command to hydraulic subsystems 304a, 304b, 304c which in turn can respectively deploys their fluid volumes relative to actuator stages 302a, 302b, 302c such that the hydraulic fluid pressure acting on the pistons of actuator stages 302a, 302b, 302c causes the rod to be linearly displaced relative to the outer cylinder, thereby causing flight control surface 308 to be shifted to the commanded position. This process may be iteratively repeated as required to achieve the desired commanded position of flight control surface 308.

Even though the shifting of flight control surface 308 from a current position to a new position has been described as a step change in the previous example, it should be understood by those having ordinary skill in the art that the process of positioning a control surface of aircraft may occur on a continuous basis rather than as a step change or a series of step changes. For example, flight control computers 306a, 306b, 306c may simultaneously and/or continuously receive feedback from position sensor 302d as well as additional data from inputs 310 that provide new positioning information for flight control surface 308 during the course of a flight.

As discussed herein, aircraft control system 300 is a triply redundant system that provides suitable fault tolerance and suitable safety margins for aircraft implementations. In a non-limiting example, if one of flight control computers 306a, 306b, 306c has a failure or other fault, the other two of flight control computers 306a, 306b, 306c are configured to enable full functionality of hydraulic actuator 302. In addition, if two of flight control computers 306a, 306b, 306c have a failure or other fault, the other one of flight control computers 306a, 306b, 306c is configured to enable full functionality of hydraulic actuator 302. Likewise, if one of hydraulic subsystems 304a, 304b, 304c has a failure or other fault, the other two of hydraulic subsystems 304a, 304b, 304c are configured to enable full functionality of hydraulic actuator 302. In addition, if two of hydraulic subsystems 304a, 304b, 304c have a failure or other fault, the other one of hydraulic subsystems 304a, 304b, 304c is configured to enable full functionality of hydraulic actuator 302. Similarly, if one of actuator stages 304a, 304b, 304c has a failure or other fault, the other two of actuator stages 304a, 304b, 304c are configured to enable full functionality of hydraulic actuator 302. In addition, if two of actuator stages 304a, 304b, 304c have a failure or other fault, the other one of actuator stages 304a, 304b, 304c is configured to enable full functionality of hydraulic actuator 302. In this manner, aircraft control system 300 is a triply redundant system.

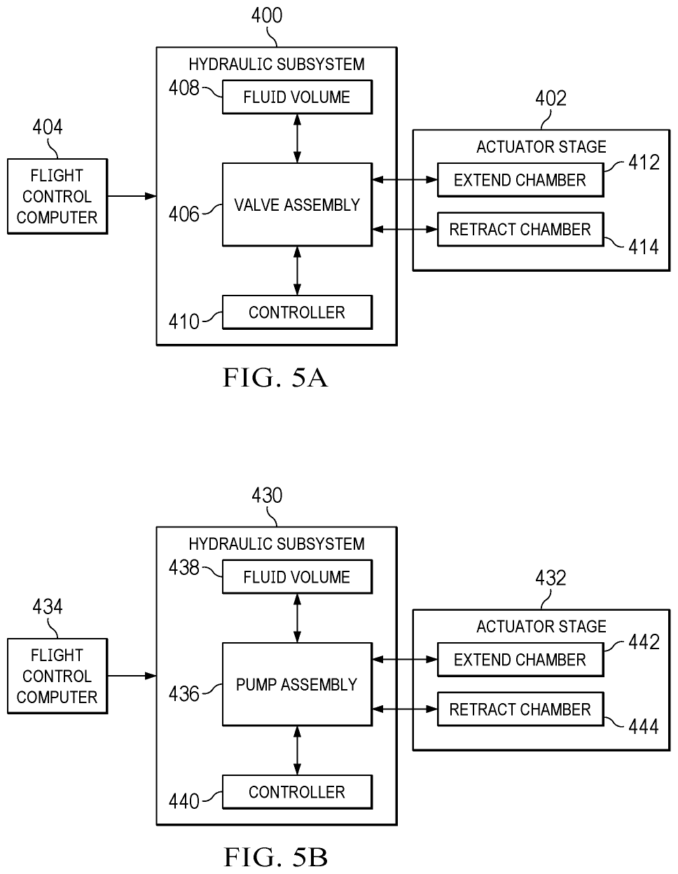

Referring now to FIGS. 5A-5B of the drawings, addition details regarding the hydraulic subsystems of the present disclosure will now be discussed. In FIG. 5A, hydraulic subsystem 400 provides hydraulic fluid pressure to actuator stage 402 responsive to commands from flight control computer 404. It should be noted that hydraulic subsystem 400 is representative of hydraulic subsystems 104a, 104b, 104c, 304a, 304b, 304c discussed herein, actuator stage 402 is representative of actuator stages 204a, 204b, 204c, 302a, 302b, 302c discussed herein and flight control computer 404 is representative of flight control computers 306a, 306b, 306c. In the illustrated embodiments, hydraulic subsystem 400 includes a valve assembly 406, a self-contained fluid volume 408 and a controller 410. Valve assembly 406 includes a motor and a servo valve such as a three position, four way directional control spool valve that distributes the hydraulic fluid. Fluid volume 408 represents a source of pressurized hydraulic fluid that is supplied to valve assembly 406 using, for example, a pump to circulate hydraulic fluid to valve assembly 406 from a hydraulic fluid reservoir that also receives return hydraulic fluid from valve assembly 406.

In operation, flight control computer 404 sends commands to hydraulic subsystem 400 to cause, for example, flight control surface 308 of FIG. 4 to be shifted to a commanded position. Controller 410 processes the commands, ensures that pressurized hydraulic fluid is being supplied to valve assembly 406 and then operates valve assembly 406 to the appropriate position to direct hydraulic fluid from fluid volume 408 to one of extend chamber 412 and retract chamber 414 of actuator stage 402. The hydraulic fluid pressure acts on the piston of actuator stage 402 to causes the rod to be linearly displaced relative to the outer cylinder, thereby causing flight control surface 308 to be shifted to the commanded position. Valve assembly 406 receives return hydraulic fluid from the other of extend chamber 412 and retract chamber 414 as the rod is linearly displaced and directs the return hydraulic fluid to the hydraulic fluid reservoir.

In FIG. 5B, hydraulic subsystem 430 provides hydraulic fluid pressure to actuator stage 432 responsive to commands from flight control computer 434. It should be noted that hydraulic subsystem 430 is representative of hydraulic subsystems 104a, 104b, 104c, 304a, 304b, 304c discussed herein, actuator stage 432 is representative of actuator stages 204a, 204b, 204c, 302a, 302b, 302c discussed herein and flight control computer 434 is representative of flight control computers 306a, 306b, 306c. In the illustrated embodiments, hydraulic subsystem 430 includes a pump assembly 436, a self-contained fluid volume 438 and a controller 440. Pump assembly 436 includes a motor and a bidirectional pump such as a bidirectional gear pump that distributes the hydraulic fluid. Fluid volume 438 represents a source of pressurized hydraulic fluid.

In operation, flight control computer 434 sends commands to hydraulic subsystem 430 to cause, for example, flight control surface 308 of FIG. 4 to be shifted to a commanded position. Controller 440 processes the commands, then activates the motor to operate the bidirectional pump in the appropriate direction to direct hydraulic fluid to one of extend chamber 442 and retract chamber 444 of actuator stage 432 while as the same time withdrawing hydraulic fluid from the other of extend chamber 442 and retract chamber 444. The hydraulic fluid pressure acts on the piston of actuator stage 432 to causes the rod to be linearly displaced relative to the outer cylinder, thereby causing flight control surface 308 to be shifted to the commanded position.

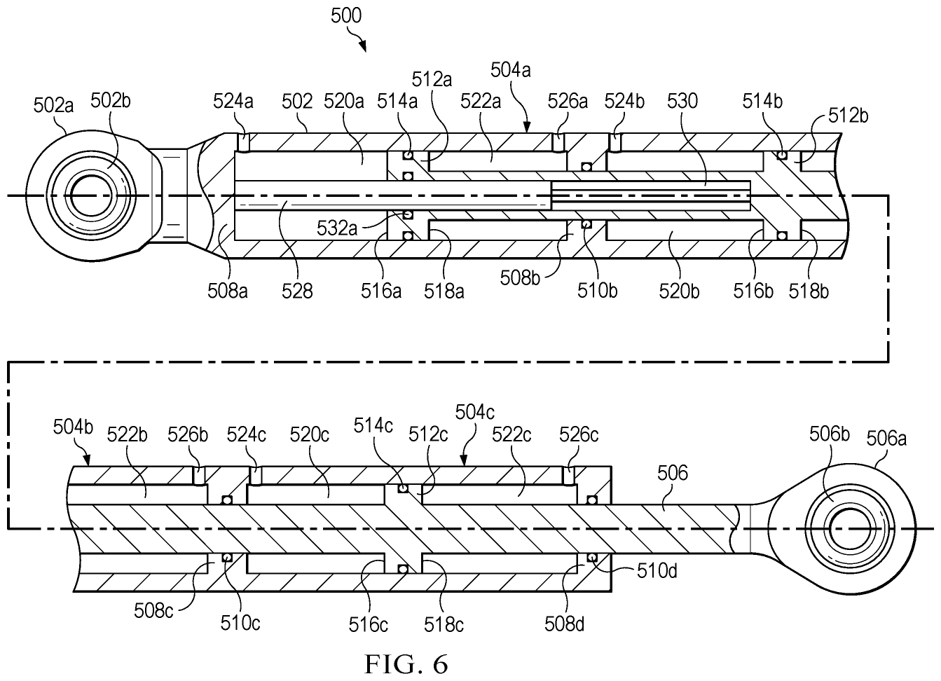

Referring next to FIG. 6 in the drawings, an axially aligned triplex linear hydraulic actuator 500, that is representative of axially aligned triplex linear hydraulic actuator 102, will now be discussed. Hydraulic actuator 500 includes an outer cylinder 502 that has a generally cylindrical outer surface and generally cylindrical inner surface. Outer cylinder 502 has a pin end 502a that houses a spherical bearing 502b configured for coupling hydraulic actuator 500 to another structure, such as airframe structure 106 discussed herein. Outer cylinder 502 encloses a volume that is divided into three actuator stages 504a, 504b, 504c that act individually and/or collectively to linearly displace a rod 506 between a plurality of positions including a retracted position, an extended position and an infinite number of positions therebetween. Actuator stages 504a, 504b, 504c are positioned within hydraulic actuator 500 in an end-to-end coaxial arrangement which may be referred to herein as being axially aligned in series. Rod 506 extends through each of actuator stages 504a, 504b, 504c and has a pin end 506a that houses a spherical bearing 506b configured for coupling hydraulic actuator 500 to another component, such as to rotating system 108 used to pivot horizontal stabilizers 110a, 110b, as discussed herein.

Hydraulic actuator 500 includes an end assembly 508a, an intermediate seal assembly 508b, an intermediate seal assembly 508c and an end seal assembly 508d, each of which may be coupled to or integrally formed with outer cylinder 502. Seal assembly 508b is sized to have a sliding and sealing relationship with rod 506 created by a seal element, depicted as an O-ring 510b, that is received within an inner gland of seal assembly 508b. Seal assembly 508c is sized to have a sliding and sealing relationship with rod 506 created by a seal element, depicted as an O-ring 510c, that is received within an inner gland of seal assembly 508c. Seal assembly 508d is sized to have a sliding and sealing relationship with rod 506 created by a seal element, depicted as an O-ring 510d, that is received within an inner gland of seal assembly 508d.

A piston 512a is coupled to rod 506 and, in the illustrated embodiment, is integrally formed with rod 506. Piston 512a includes an outer gland that is configured to receive a seal element, depicted as an O-ring 514a, therein. Piston 512a is sized such that O-ring 514a has a sliding and sealing relationship with the inner cylindrical surface of outer cylinder 502. Piston 512a has opposing surfaces referred to herein as extend surface 516a and retract surface 518a. Together, end assembly 508a, piston 512a and the inner cylindrical surface of outer cylinder 502 form a generally annular extend chamber 520a. Similarly, seal assembly 508b, piston 512a, the inner cylindrical surface of outer cylinder 502 and the outer surface of rod 506 form a generally annular retract chamber 522a. Fluid from the hydraulic fluid volume controlled by the respective hydraulic subsystem, such as hydraulic subsystem 104a discussed above, enters and exits extend chamber 520a via an extend port 524a. Likewise, fluid from the hydraulic fluid volume controlled by the respective hydraulic subsystem enters and exits retract chamber 522a via a retract port 526a. Extend chamber 520a, retract chamber 522a and piston 512a are part of actuator stage 504a such that when the hydraulic subsystem supplies hydraulic fluid to extend chamber 520a via extend port 524a and withdraws hydraulic fluid from retract chamber 522a via retract port 526a, the hydraulic fluid pressure in extend chamber 520a acts on extend surface 516a of piston 512a which urges rod 506 toward the extended position, and such that when the hydraulic subsystem supplies hydraulic fluid to retract chamber 522a via retract port 526a and withdraws hydraulic fluid from extend chamber 520a via extend port 524a, the hydraulic fluid pressure in retract chamber 522a acts on retract surface 518a of piston 512a which urges rod 506 toward the retracted position.

A piston 512b is coupled to rod 506 and, in the illustrated embodiment, is integrally formed with rod 506. Piston 512b includes an outer gland that is configured to receive a seal element, depicted as an O-ring 514b, therein. Piston 512b is sized such that O-ring 514b has a sliding and sealing relationship with the inner cylindrical surface of outer cylinder 502. Piston 512b has opposing surfaces referred to herein as extend surface 516b and retract surface 518b. Together, seal assembly 508b, piston 512b, the inner cylindrical surface of outer cylinder 502 and the outer surface of rod 506 form a generally annular extend chamber 520b. Similarly, seal assembly 508c, piston 512b, the inner cylindrical surface of outer cylinder 502 and the outer surface of rod 506 form a generally annular retract chamber 522b. Fluid from the hydraulic fluid volume controlled by the respective hydraulic subsystem, such as hydraulic subsystem 104b discussed above, enters and exits extend chamber 520b via an extend port 524b. Likewise, fluid from the hydraulic fluid volume controlled by the respective hydraulic subsystem enters and exits retract chamber 522b via a retract port 526b. Extend chamber 520b, retract chamber 522b and piston 512b are part of actuator stage 504b such that when the hydraulic subsystem supplies hydraulic fluid to extend chamber 520b via extend port 524b and withdraws hydraulic fluid from retract chamber 522b via retract port 526b, the hydraulic fluid pressure in extend chamber 520b acts on extend surface 516b of piston 512b which urges rod 506 toward the extended position, and such that when the hydraulic subsystem supplies hydraulic fluid to retract chamber 522b via retract port 526b and withdraws hydraulic fluid from extend chamber 520b via extend port 524b, the hydraulic fluid pressure in retract chamber 522b acts on retract surface 518b of piston 512b which urges rod 506 toward the retracted position.

A piston 512c is coupled to rod 506 and, in the illustrated embodiment, is integrally formed with rod 506. Piston 512c includes an outer gland that is configured to receive a seal element, depicted as an O-ring 514c, therein. Piston 512c is sized such that O-ring 514c has a sliding and sealing relationship with the inner cylindrical surface of outer cylinder 502. Piston 512c has opposing surfaces referred to herein as extend surface 516c and retract surface 518c. Together, seal assembly 508c, piston 512c, the inner cylindrical surface of outer cylinder 502 and the outer surface of rod 506 form a generally annular extend chamber 520c. Similarly, seal assembly 508d, piston 512c, the inner cylindrical surface of outer cylinder 502 and the outer surface of rod 506 form a generally annular retract chamber 522c. Fluid from the hydraulic fluid volume controlled by the respective hydraulic subsystem, such as hydraulic subsystem 104c discussed above, enters and exits extend chamber 520c via an extend port 524c. Likewise, fluid from the hydraulic fluid volume controlled by the respective hydraulic subsystem enters and exits retract chamber 522c via a retract port 526c. Extend chamber 520c, retract chamber 522c and piston 512c are part of actuator stage 504c such that when the hydraulic subsystem supplies hydraulic fluid to extend chamber 520c via extend port 524c and withdraws hydraulic fluid from retract chamber 522c via retract port 526c, the hydraulic fluid pressure in extend chamber 520c acts on extend surface 516c of piston 512c which urges rod 506 toward the extended position, and such that when the hydraulic subsystem supplies hydraulic fluid to retract chamber 522c via retract port 526c and withdraws hydraulic fluid from extend chamber 520c via extend port 524c, the hydraulic fluid pressure in retract chamber 522c acts on retract surface 518c of piston 512c which urges rod 506 toward the retracted position.

In the illustrated embodiment, hydraulic actuator 500 includes a variable differential transformer 528 that converts the linear displacement of rod 506 relative to outer cylinder 502 into a proportional electrical signal that is sent to flight control computer system 38b. Preferably, variable differential transformer 528 is a triplex linear variable differential transformer that is configured to convert the linear displacement of rod 506 relative to outer cylinder 502 into three independent proportional electrical signals that are respectively sent to the three independent flight control computers of flight control computer system 38b. In the illustrated embodiment, variable differential transformer 528 is isolated from the hydraulic fluid and is at least partially positioned within a dry chamber 530. Piston 512a includes an inner gland that is configured to receive a seal element, depicted as an O-ring 532a, therein. Piston 512a is sized such that O-ring 532a has a sliding and sealing relationship with an outer cylindrical surface of variable differential transformer 528.

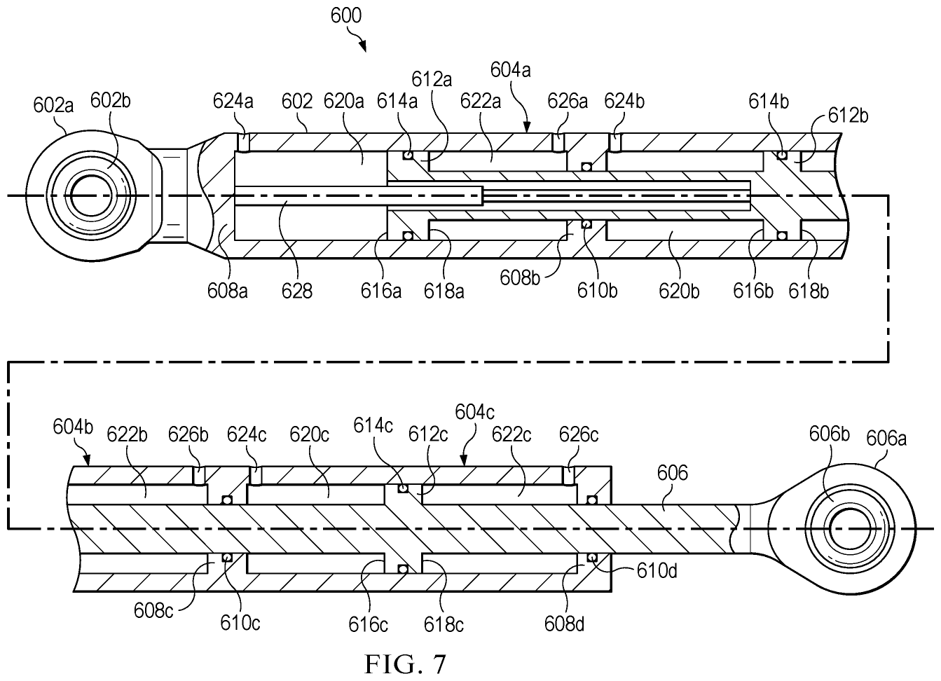

Referring next to FIG. 7 in the drawings, an axially aligned triplex linear hydraulic actuator 600, that is representative of axially aligned triplex linear hydraulic actuator 102, will now be discussed. Hydraulic actuator 600 includes an outer cylinder 602 that has a generally cylindrical outer surface and generally cylindrical inner surface. Outer cylinder 602 has a pin end 602a that houses a spherical bearing 602b configured for coupling hydraulic actuator 600 to another structure, such as airframe structure 106 discussed herein. Outer cylinder 602 encloses a volume that is divided into three actuator stages 604a, 604b, 604c that act individually and/or collectively to linearly displace a rod 606 between a plurality of positions including a retracted position, an extended position and an infinite number of positions therebetween. Actuator stages 604a, 604b, 604c are positioned within hydraulic actuator 600 in an end-to-end coaxial arrangement which may be referred to herein as being axially aligned in series. Rod 606 extends through each of actuator stages 604a, 604b, 604c and has a pin end 606a that houses a spherical bearing 606b configured for coupling hydraulic actuator 600 to another component, such as to rotating system 108 used to pivot horizontal stabilizers 110a, 110b, as discussed herein.

Hydraulic actuator 600 includes an end assembly 608a, an intermediate seal assembly 608b, an intermediate seal assembly 608c and an end seal assembly 608d, each of which may be coupled to or integrally formed with outer cylinder 602. Seal assembly 608b is sized to have a sliding and sealing relationship with rod 606 created by a seal element, depicted as an O-ring 610b, that is received within an inner gland of seal assembly 608b. Seal assembly 608c is sized to have a sliding and sealing relationship with rod 606 created by a seal element, depicted as an O-ring 610c, that is received within an inner gland of seal assembly 608c. Seal assembly 608d is sized to have a sliding and sealing relationship with rod 606 created by a seal element, depicted as an O-ring 610d, that is received within an inner gland of seal assembly 608d.

A piston 612a is coupled to rod 606 and, in the illustrated embodiment, is integrally formed with rod 606. Piston 612a includes an outer gland that is configured to receive a seal element, depicted as an O-ring 614a, therein. Piston 612a is sized such that O-ring 614a has a sliding and sealing relationship with the inner cylindrical surface of outer cylinder 602. Piston 612a has opposing surfaces referred to herein as extend surface 616a and retract surface 618a. Together, end assembly 608a, piston 612a, the inner cylindrical surface of outer cylinder 602 and an inner portion of rod 606 form a multi annular extend chamber 620a. Similarly, seal assembly 608b, piston 612a, the inner cylindrical surface of outer cylinder 602 and the outer surface of rod 606 form a generally annular retract chamber 622a. Fluid from the hydraulic fluid volume controlled by the respective hydraulic subsystem, such as hydraulic subsystem 104a discussed above, enters and exits extend chamber 620a via an extend port 624a. Likewise, fluid from the hydraulic fluid volume controlled by the respective hydraulic subsystem enters and exits retract chamber 622a via a retract port 626a. Extend chamber 620a, retract chamber 622a and piston 612a are part of actuator stage 604a such that when the hydraulic subsystem supplies hydraulic fluid to extend chamber 620a via extend port 624a and withdraws hydraulic fluid from retract chamber 622a via retract port 626a, the hydraulic fluid pressure in extend chamber 620a acts on extend surface 616a of piston 612a which urges rod 606 toward the extended position, and such that when the hydraulic subsystem supplies hydraulic fluid to retract chamber 622a via retract port 626a and withdraws hydraulic fluid from extend chamber 620a via extend port 624a, the hydraulic fluid pressure in retract chamber 622a acts on retract surface 618a of piston 612a which urges rod 606 toward the retracted position.

A piston 612b is coupled to rod 606 and, in the illustrated embodiment, is integrally formed with rod 606. Piston 612b includes an outer gland that is configured to receive a seal element, depicted as an O-ring 614b, therein. Piston 612b is sized such that O-ring 614b has a sliding and sealing relationship with the inner cylindrical surface of outer cylinder 602. Piston 612b has opposing surfaces referred to herein as extend surface 616b and retract surface 618b. Together, seal assembly 608b, piston 612b, the inner cylindrical surface of outer cylinder 602 and the outer surface of rod 606 form a generally annular extend chamber 620b. Similarly, seal assembly 608c, piston 612b, the inner cylindrical surface of outer cylinder 602 and the outer surface of rod 606 form a generally annular retract chamber 622b. Fluid from the hydraulic fluid volume controlled by the respective hydraulic subsystem, such as hydraulic subsystem 104b discussed above, enters and exits extend chamber 620b via an extend port 624b. Likewise, fluid from the hydraulic fluid volume controlled by the respective hydraulic subsystem enters and exits retract chamber 622b via a retract port 626b. Extend chamber 620b, retract chamber 622b and piston 612b are part of actuator stage 604b such that when the hydraulic subsystem supplies hydraulic fluid to extend chamber 620b via extend port 624b and withdraws hydraulic fluid from retract chamber 622b via retract port 626b, the hydraulic fluid pressure in extend chamber 620b acts on extend surface 616b of piston 612b which urges rod 606 toward the extended position, and such that when the hydraulic subsystem supplies hydraulic fluid to retract chamber 622b via retract port 626b and withdraws hydraulic fluid from extend chamber 620b via extend port 624b, the hydraulic fluid pressure in retract chamber 622b acts on retract surface 618b of piston 612b which urges rod 606 toward the retracted position.

A piston 612c is coupled to rod 606 and, in the illustrated embodiment, is integrally formed with rod 606. Piston 612c includes an outer gland that is configured to receive a seal element, depicted as an O-ring 614c, therein. Piston 612c is sized such that O-ring 614c has a sliding and sealing relationship with the inner cylindrical surface of outer cylinder 602. Piston 612c has opposing surfaces referred to herein as extend surface 616c and retract surface 618c. Together, seal assembly 608c, piston 612c, the inner cylindrical surface of outer cylinder 602 and the outer surface of rod 606 form a generally annular extend chamber 620c. Similarly, seal assembly 608d, piston 612c, the inner cylindrical surface of outer cylinder 602 and the outer surface of rod 606 form a generally annular retract chamber 622c. Fluid from the hydraulic fluid volume controlled by the respective hydraulic subsystem, such as hydraulic subsystem 104c discussed above, enters and exits extend chamber 620c via an extend port 624c. Likewise, fluid from the hydraulic fluid volume controlled by the respective hydraulic subsystem enters and exits retract chamber 622c via a retract port 626c. Extend chamber 620c, retract chamber 622c and piston 612c are part of actuator stage 604c such that when the hydraulic subsystem supplies hydraulic fluid to extend chamber 620c via extend port 624c and withdraws hydraulic fluid from retract chamber 622c via retract port 626c, the hydraulic fluid pressure in extend chamber 620c acts on extend surface 616c of piston 612c which urges rod 606 toward the extended position, and such that when the hydraulic subsystem supplies hydraulic fluid to retract chamber 622c via retract port 626c and withdraws hydraulic fluid from extend chamber 620c via extend port 624c, the hydraulic fluid pressure in retract chamber 622c acts on retract surface 618c of piston 612c which urges rod 606 toward the retracted position.

In the illustrated embodiment, hydraulic actuator 600 includes a variable differential transformer 628 that converts the linear displacement of rod 606 relative to outer cylinder 602 into a proportional electrical signal that is sent to flight control computer system 38b. Preferably, variable differential transformer 628 is a triplex linear variable differential transformer that is configured to convert the linear displacement of rod 606 relative to outer cylinder 602 into three independent proportional electrical signals that are respectively sent to the three independent flight control computers of flight control computer system 38b. In the illustrated embodiment, variable differential transformer 628 is disposed within extend chamber 620a and is thus exposed to the hydraulic fluid therein.

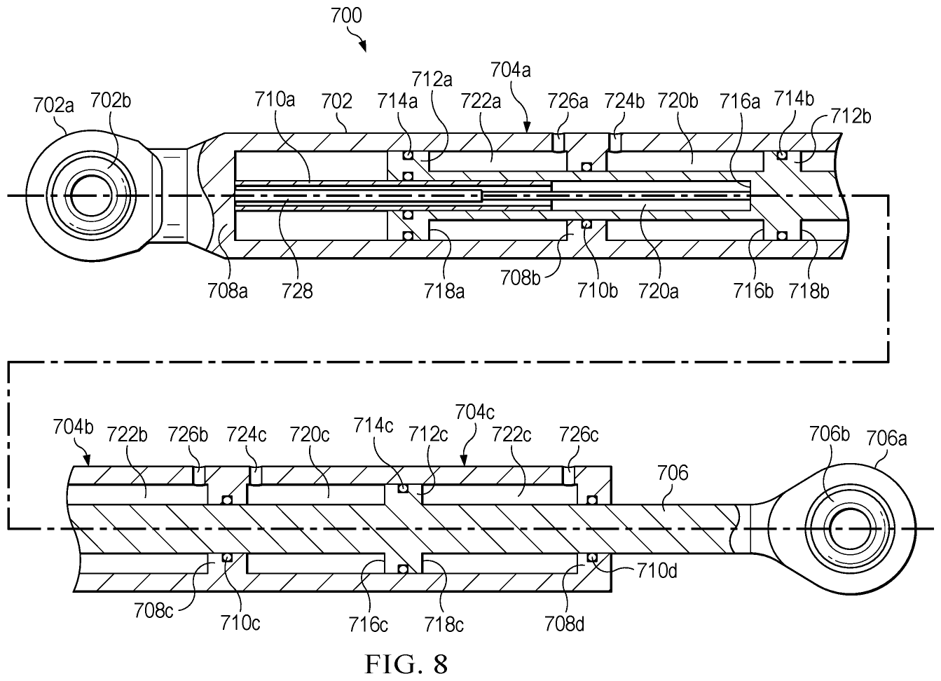

Referring next to FIG. 8 in the drawings, an axially aligned triplex linear hydraulic actuator 700, that is representative of axially aligned triplex linear hydraulic actuator 102, will now be discussed. Hydraulic actuator 700 includes an outer cylinder 702 that has a generally cylindrical outer surface and generally cylindrical inner surface. Outer cylinder 702 has a pin end 702a that houses a spherical bearing 702b configured for coupling hydraulic actuator 700 to another structure, such as airframe structure 106 discussed herein. Outer cylinder 702 encloses a volume that is divided into three actuator stages 704a, 704b, 704c that act individually and/or collectively to linearly displace a rod 706 between a plurality of positions including a retracted position, an extended position and an infinite number of positions therebetween. Actuator stages 704a, 704b, 704c are positioned within hydraulic actuator 700 in an end-to-end coaxial arrangement which may be referred to herein as being axially aligned in series. Rod 706 extends through each of actuator stages 704a, 704b, 704c and has a pin end 706a that houses a spherical bearing 706b configured for coupling hydraulic actuator 700 to another component, such as to rotating system 108 used to pivot horizontal stabilizers 110a, 110b, as discussed herein.

Hydraulic actuator 700 includes an end assembly 708a, an intermediate seal assembly 708b, an intermediate seal assembly 708c and an end seal assembly 708d, each of which may be coupled to or integrally formed with outer cylinder 702. End assembly 708a includes a sleeve 710a that is coupled thereto or integrally formed therewith. Seal assembly 708b is sized to have a sliding and sealing relationship with rod 706 created by a seal element, depicted as an O-ring 710b, that is received within an inner gland of seal assembly 708b. Seal assembly 708c is sized to have a sliding and sealing relationship with rod 706 created by a seal element, depicted as an O-ring 710c, that is received within an inner gland of seal assembly 708c. Seal assembly 708d is sized to have a sliding and sealing relationship with rod 706 created by a seal element, depicted as an O-ring 710d, that is received within an inner gland of seal assembly 708d.

A piston 712a is coupled to rod 706 and, in the illustrated embodiment, is integrally formed with rod 706. Piston 712a includes an outer gland that is configured to receive a seal element, depicted as an O-ring 714a, therein. Piston 712a is sized such that O-ring 714a has a sliding and sealing relationship with the inner cylindrical surface of outer cylinder 702. In the illustrated embodiment, rod 706 has an extend surface 716a and piston 712a has a retract surface 718a. Together, sleeve 710a and an inner portion of rod 706 form a generally annular extend chamber 720a. Similarly, seal assembly 708b, piston 712a, the inner cylindrical surface of outer cylinder 702 and the outer surface of rod 706 form a generally annular retract chamber 722a. Fluid from the hydraulic fluid volume controlled by the respective hydraulic subsystem, such as hydraulic subsystem 104a discussed above, enters and exits extend chamber 720a via an extend port (not visible). Likewise, fluid from the hydraulic fluid volume controlled by the respective hydraulic subsystem enters and exits retract chamber 722a via a retract port 726a. Extend chamber 720a, retract chamber 722a and piston 712a are part of actuator stage 704a such that when the hydraulic subsystem supplies hydraulic fluid to extend chamber 720a via the extend port and withdraws hydraulic fluid from retract chamber 722a via retract port 726a, the hydraulic fluid pressure in extend chamber 720a acts on extend surface 716a of rod 706 which urges rod 706 toward the extended position, and such that when the hydraulic subsystem supplies hydraulic fluid to retract chamber 722a via retract port 726a and withdraws hydraulic fluid from extend chamber 720a via the extend port, the hydraulic fluid pressure in retract chamber 722a acts on retract surface 718a of piston 712a which urges rod 706 toward the retracted position.

A piston 712b is coupled to rod 706 and, in the illustrated embodiment, is integrally formed with rod 706. Piston 712b includes an outer gland that is configured to receive a seal element, depicted as an O-ring 714b, therein. Piston 712b is sized such that O-ring 714b has a sliding and sealing relationship with the inner cylindrical surface of outer cylinder 702. Piston 712b has opposing surfaces referred to herein as extend surface 716b and retract surface 718b. Together, seal assembly 708b, piston 712b, the inner cylindrical surface of outer cylinder 702 and the outer surface of rod 706 form a generally annular extend chamber 720b. Similarly, seal assembly 708c, piston 712b, the inner cylindrical surface of outer cylinder 702 and the outer surface of rod 706 form a generally annular retract chamber 722b. Fluid from the hydraulic fluid volume controlled by the respective hydraulic subsystem, such as hydraulic subsystem 104b discussed above, enters and exits extend chamber 720b via an extend port 724b. Likewise, fluid from the hydraulic fluid volume controlled by the respective hydraulic subsystem enters and exits retract chamber 722b via a retract port 726b. Extend chamber 720b, retract chamber 722b and piston 712b are part of actuator stage 704b such that when the hydraulic subsystem supplies hydraulic fluid to extend chamber 720b via extend port 724b and withdraws hydraulic fluid from retract chamber 722b via retract port 726b, the hydraulic fluid pressure in extend chamber 720b acts on extend surface 716b of piston 712b which urges rod 706 toward the extended position, and such that when the hydraulic subsystem supplies hydraulic fluid to retract chamber 722b via retract port 726b and withdraws hydraulic fluid from extend chamber 720b via extend port 724b, the hydraulic fluid pressure in retract chamber 722b acts on retract surface 718b of piston 712b which urges rod 706 toward the retracted position.

A piston 712c is coupled to rod 706 and, in the illustrated embodiment, is integrally formed with rod 706. Piston 712c includes an outer gland that is configured to receive a seal element, depicted as an O-ring 714c, therein. Piston 712c is sized such that O-ring 714c has a sliding and sealing relationship with the inner cylindrical surface of outer cylinder 702. Piston 712c has opposing surfaces referred to herein as extend surface 716c and retract surface 718c. Together, seal assembly 708c, piston 712c, the inner cylindrical surface of outer cylinder 702 and the outer surface of rod 706 form a generally annular extend chamber 720c. Similarly, seal assembly 708d, piston 712c, the inner cylindrical surface of outer cylinder 702 and the outer surface of rod 706 form a generally annular retract chamber 722c. Fluid from the hydraulic fluid volume controlled by the respective hydraulic subsystem, such as hydraulic subsystem 104c discussed above, enters and exits extend chamber 720c via an extend port 724c. Likewise, fluid from the hydraulic fluid volume controlled by the respective hydraulic subsystem enters and exits retract chamber 722c via a retract port 726c. Extend chamber 720c, retract chamber 722c and piston 712c are part of actuator stage 704c such that when the hydraulic subsystem supplies hydraulic fluid to extend chamber 720c via extend port 724c and withdraws hydraulic fluid from retract chamber 722c via retract port 726c, the hydraulic fluid pressure in extend chamber 720c acts on extend surface 716c of piston 712c which urges rod 706 toward the extended position, and such that when the hydraulic subsystem supplies hydraulic fluid to retract chamber 722c via retract port 726c and withdraws hydraulic fluid from extend chamber 720c via extend port 724c, the hydraulic fluid pressure in retract chamber 722c acts on retract surface 718c of piston 712c which urges rod 706 toward the retracted position.

In the illustrated embodiment, hydraulic actuator 700 includes a variable differential transformer 728 that converts the linear displacement of rod 706 relative to outer cylinder 702 into a proportional electrical signal that is sent to flight control computer system 38b. Preferably, variable differential transformer 728 is a triplex linear variable differential transformer that is configured to convert the linear displacement of rod 706 relative to outer cylinder 702 into three independent proportional electrical signals that are respectively sent to the three independent flight control computers of flight control computer system 38b. In the illustrated embodiment, variable differential transformer 728 is disposed within extend chamber 720a and is thus exposed to the hydraulic fluid therein.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. An aircraft control system for positioning an aircraft component, the aircraft control system comprising:
an actuator including an outer cylinder, a rod disposed at least partially within the outer cylinder and first, second and third pistons coupled to the rod, the rod linearly displaceable relative to the outer cylinder between a plurality of positions including a retracted position and an extended position, the first, second and third pistons slidably and sealing received within the outer cylinder; and
a hydraulic system having first, second and third fluid volumes, the first fluid volume configured to act on the first piston to form a first actuator stage, the second fluid volume configured to act on the second piston to form a second actuator stage and the third fluid volume configured to act on the third piston to form a third actuator stage;
wherein, the first, second and third fluid volumes are separately controllable; and
wherein, the first, second and third actuator stages are axially aligned.

2. The aircraft control system as recited in claim 1 wherein, the hydraulic system further comprises:
a first hydraulic subsystem configured to control the first fluid volume;
a second hydraulic subsystem configured to control the second fluid volume; and
a third hydraulic subsystem configured to control the third fluid volume.

3. The aircraft control system as recited in claim 2 wherein, the first hydraulic subsystem further comprises a first hydraulic reservoir, a first hydraulic pump and a first hydraulic valve assembly;
wherein, the second hydraulic subsystem further comprises a second hydraulic reservoir, a second hydraulic pump and a second hydraulic valve assembly; and
wherein, the third hydraulic subsystem further comprises a third hydraulic reservoir, a third hydraulic pump and a third hydraulic valve assembly.

4. The aircraft control system as recited in claim 2 wherein, the first hydraulic subsystem further comprises a first hydraulic reservoir, a first electric motor and a first hydraulic valve assembly;
wherein, the second hydraulic subsystem further comprises a second hydraulic reservoir, a second electric motor and a second hydraulic valve assembly; and
wherein, the third hydraulic subsystem further comprises a third hydraulic reservoir, a third electric motor and a third hydraulic valve assembly.

5. The aircraft control system as recited in claim 2 further comprising:
a first flight control computer operably associated with the first hydraulic subsystem;
a second flight control computer operably associated with the second hydraulic subsystem; and
a third flight control computer operably associated with the third hydraulic subsystem.

6. The aircraft control system as recited in claim 5 wherein, the actuator further comprises a linear variable differential transformer configured to convert linear displacements of the rod relative to the outer cylinder into proportional electrical signals sent to the first, second and third flight control computers.

7. The aircraft control system as recited in claim 5 wherein, the actuator further comprises a triplex linear variable differential transformer configured to convert linear displacements of the rod relative to the outer cylinder into first, second and third proportional electrical signals that are respectively sent to the first, second and third flight control computers.

8. The aircraft control system as recited in claim 1 wherein, the first actuator stage further comprises a first extend chamber and a first retract chamber positioned on opposite sides of the first piston and disposed between the outer cylinder and the rod;
wherein, the second actuator stage further comprises a second extend chamber and a second retract chamber positioned on opposite sides of the second piston and disposed between the outer cylinder and the rod; and
wherein, the third actuator stage further comprises a third extend chamber and a third retract chamber positioned on opposite sides of the third piston and disposed between the outer cylinder and the rod.

9. The aircraft control system as recited in claim 8 wherein, the first piston further comprises a first extend surface and a first retract surface;
wherein, the second piston further comprises a second extend surface and a second retract surface; and
wherein, the third piston further comprises a third extend surface and a third retract surface.

10. The aircraft control system as recited in claim 9 wherein, fluid from the first fluid volume in the first extend chamber acting on the first extend surface urges the rod toward the extended position;
wherein, fluid from the second fluid volume in the second extend chamber acting on the second extend surface urges the rod toward the extended position; and
wherein, fluid from the third fluid volume in the third extend chamber acting on the third extend surface urges the rod toward the extended position.

11. The aircraft control system as recited in claim 9 wherein, fluid from the first fluid volume in the first retract chamber acting on the first retract surface urges the rod toward the retracted position;
wherein, fluid from the second fluid volume in the second retract chamber acting on the second retract surface urges the rod toward the retracted position; and
wherein, fluid from the third fluid volume in the third retract chamber acting on the third retract surface urges the rod toward the retracted position.

12. The aircraft control system as recited in claim 8 further comprising first and second seal assemblies disposed between the outer cylinder and the rod;
wherein, the first seal assembly isolates the first fluid volume in the first actuator stage from the second fluid volume in the second actuator stage; and
wherein, the second seal assembly isolates the second fluid volume in the second actuator stage from the third fluid volume in the third actuator stage.

13. The aircraft control system as recited in claim 1 wherein, responsive to a malfunction in one of the three actuator stages, the other two of the three actuator stages are configured to linearly displace the rod relative to the outer cylinder between the plurality of positions, thereby providing redundancy to the aircraft control system.

14. The aircraft control system as recited in claim 1 wherein, responsive to a malfunction in two of the three actuator stages, the other of the three actuator stages is configured to linearly displace the rod relative to the outer cylinder between the plurality of positions, thereby providing redundancy to the aircraft control system.

15. The aircraft control system as recited in claim 1 wherein, the first, second and third actuator stages are axially aligned in series such that the first, second and third actuator stages are positioned in an end-to-end coaxial arrangement.

16. An aircraft comprising:
an airframe;
an aircraft component coupled to and selectively positionable relative to the airframe;
an actuator including an outer cylinder, a rod disposed at least partially within the outer cylinder and first, second and third pistons coupled to the rod, the outer cylinder coupled to the airframe, the rod coupled to the aircraft component and linearly displaceable relative to the outer cylinder between a plurality of positions including a retracted position and an extended position, the first, second and third pistons slidably and sealing received within the outer cylinder; and
a hydraulic system having first, second and third fluid volumes, the first fluid volume configured to act on the first piston to form a first actuator stage, the second fluid volume configured to act on the second piston to form a second actuator stage and the third fluid volume configured to act on the third piston to form a third actuator stage;
wherein, the first, second and third fluid volumes are separately controllable; and
wherein, the first, second and third actuator stages are axially aligned;

17. The aircraft as recited in claim 16 wherein, the aircraft is a rotorcraft.

18. The aircraft as recited in claim 16 wherein, the aircraft component is a flight control surface.

19. The aircraft as recited in claim 18 wherein, the flight control surface is a horizontal stabilizer.

20. The aircraft as recited in claim 15 wherein, the outer cylinder includes a pin end coupled to the airframe; and
wherein, the rod has a pin end coupled to the aircraft component such that linear displacement of the rod relative to the outer cylinder changes a position of the aircraft component relative to the airframe.
